(19) United States
(12) Patent Application Publication
(10) Pub. No.: US 2005/0142421 A1
(43) Pub. Date: Jun. 30, 2005

(54) Device for the circulation of at least one fuel cell with a medium as well as a fuel cell system

(76) Inventors: Grigorios Lisgaras, Munchen (DE); Miquel Angel Alonso Nogueiro, Munchen (DE)

Correspondence Address: KRIEGSMAN & KRIEGSMAN, 665 Franklin Street, Framingham, MA, 01702, US

(21) Appl. No.: 10/939,957

(22) Filed: Sep. 13, 2004

(30) Foreign Application Priority Data
Sep. 15, 2003 (DE) 103 42 470.9

(51) Int. Cl. H01M 8/02

(52) U.S. Cl. 429/38; 429/39

(57) ABSTRACT

Described, among other things, is a device (30) for the circulation of at least one fuel cell with a medium, wherein the fuel cell(s) can be a component part of fuel cells stacks (11, 12) of a fuel cell system (10). The device (30) has at least one medium feed inlet for supplying the medium to the fuel cells as well as at least one delivery device (50), arranged in the medium feed inlet, for the production of a defined volume flow of medium with a defined flow direction. The medium feed inlet opens into a distributing chamber (33), in which the medium can distribute itself prior to entering the fuel cells. The distributing chamber (33) can be brought into contact directly with the fuel cells, so that the entry of the medium into the fuel cells can occur over a predetermined region of the fuel cells. In order to achieve an especially uniform circulation, it is provided for, in accordance with the invention, that the device is constructed in such a way that the medium enters or can enter the fuel cells over the entire length of the distributing chamber (33) with a defined flow characteristic in the predetermined region and that, in an entrance region (35) of the distributing chamber (33), there are provided means for the defined distribution of the volume flow of medium into the distributing chamber (33). Furthermore, a correspondingly improved fuel cell system (10) is described.

The present invention concerns, first of all, a device for the circulation of at least one fuel cell with a medium in accordance with the preamble of patent claim 1. The invention is further directed at a fuel cell system in accordance with the preamble of patent claim 20.

Fuel cell systems have already been known for a long time and have acquired substantial importance in recent years. Similar to battery systems, fuel cell systems produce electrical energy via a chemical pathway, the individual reactants being continuously supplied and the reaction products being continuously carried away.

In a fuel cell, the oxidation and reduction processes proceeding between electrically neutral molecules or atoms are, as a rule, separated in space by an electrolyte. A fuel cell consists fundamentally of an anode part, to which a fuel is supplied. The fuel cell further has a cathode part, to which an oxidizing agent is supplied. The anode and cathode parts are separated in space by the electrolyte. Such an electrolyte can involve, for example, a membrane. Such membranes have the ability of conducting ions, but of retaining gases. The electrons released during the oxidation can be passed as electric current through a consumer.

As gaseous reaction partner for the fuel cell, it is possible to use, for example, hydrogen as the fuel and oxygen as the oxidizing agent.

If it is desired to operate the fuel cell with a fuel that is readily available or easier to store, such as natural gas, methanol, gasoline, diesel, or other hydrocarbons, it is necessary, first of all, to transform the hydrocarbon into a hydrogen-rich gas in a device for producing/processing a fuel in a so-called reforming process. This device for producing/processing a fuel consists, for example, of a metering unit, a reactor for the reforming—for example, for steam reforming—and a gas purifier as well as, often, at least one catalytic combustion device for providing process heat for the endothermic processes—for example, for the reforming process.

A fuel cell system consists, as a rule, of several fuel cells, which, in turn, can be formed of individual layers, for example. The fuel cells are preferably arranged in series; for example, they are stacked one on top of the other in a sandwich-like manner. A fuel cell system designed in this way is then referred to as a fuel cell pile or fuel cell stack.

During the operation of the fuel cell, there is formed, in addition to heat, also water, which has to be carried away. If the process water were not carried away out of the fuel cell, the fuel cell would be flooded and its efficiency would thereby be at the least strongly reduced. Furthermore, it is necessary that a certain level of moisture always prevails in the fuel cell during its operation. Without a certain moisture, the electrolyte of the fuel cell, for example, Would dry out and this, in turn, would lead to losses in power or even damage to the fuel cell. It is necessary, therefore, to establish a suitable moisture control within the fuel cell.

It is also required that, during its operation, the fuel cell be heated or else cooled. For fuel cell systems, it can be advantageous to cool and to dehumidify the moist flow of medium by means of a condenser. Water that is recovered in this way can be returned to the fuel cell system. Such a solution is described in DE 199 41,711 A1, for example, in which both the fuel cell and the condenser are cooled by means of a gaseous or else liquid cooling medium, preferably air or water. According to this known solution, the flow of cooling medium is introduced into the fuel cell via a delivery device constructed as a ventilator. The ventilator can be arranged either on the upstream side or the downstream side of the elements being cooled.

In general, known fuel cell systems have at least one fuel cell, the fuel cell being connected to at least one feed inlet for a flow of medium and to at least one outlet for a flow of medium. Provided for circulation of the fuel cell with a medium is a device that has at least one delivery device arranged in the medium feed inlet. The delivery device allows a defined volume flow of medium with a defined flow direction to be produced.

In the context of the present invention, the term “circulation” means, first of all, that a medium is introduced into the fuel cell via the medium feed inlet. However, the term also includes those design variants in which a medium is introduced into the fuel cell via a medium feed inlet, is passed through the fuel cell, and is subsequently carried away out of the fuel cell through a medium outlet. The circulation of the fuel cell is not bound by direction, so that the flow direction of the medium in the direction of the fuel cell or within the fuel cell can also be reversed.

It is already known that the medium feed inlet opens into a distributing chamber situated upstream from the fuel cell(s), in which the medium can distribute itself prior to entering the fuel cell(s). Solutions of this kind are described, for example, in DE 4,120,092 C2, US 2003/0003333 A1, EP 0 274,032 B1, or JP 2003-036878 A.

Moreover, it is known from EP 0 947,024 B1 , albeit in connection with the cooling of a fuel cell, that the distributing chamber can be brought into contact directly with the at least one fuel cell, so that the entry of the medium into the fuel cell(s) occurs or else can occur over a predetermined region of the fuel cell(s).

However, all know solutions have drawbacks. For the reliable operation of the fuel cell(s), it is absolutely essential that the circulation of the fuel cell(s) with the medium occurs in an extremely homogeneous manner. Only in this way is it ensured that the fuel cell or fuel cells produces or produce a constant power. This means that the circulation process has to be given special attention. All known solutions are constructed in such a way that there is a central medium inlet, by means of which the medium is introduced into the distributing chamber. This does not make possible, however, any directed flow in the distributing chamber and thus any directed homogeneous entry of the medium into the predetermined region of the fuel cell(s).

When the supplied medium involves process gases, these cannot be supplied homogeneously, so that a homogenous operation of the fuel cell(s) is not possible.

In the previously mentioned EP 0 947,024 B1, it is indeed provided that, in the region of the central medium inlet, there are provided distributing elements that divide up the incoming flow of coolant into partial flows. Nonetheless, it is still possible for irregularities in the flow behavior, which are due, for example, to vortex formation or the like, to arise through the central medium inlet, so that even this solution does not make possible a homogeneous supply of the medium to the fuel cell(s).

The present invention is based on the object of providing a device for the circulation of at least one fuel cell with a medium, by means of which, in a simply designed way, a defined and, above all, efficient and homogeneous circulation of the fuel cell can occur. Further, a correspondingly improved fuel cell system is to be provided.

This object is solved according to the invention by means of the device with the features in accordance with the independent patent claim 1 as well as the fuel cell system with the features in accordance with the independent patent claim 20. Further advantages, features, details, aspects, and effects of the invention ensue from the subclaims, the description, and the drawings. Features and details that are described in connection with the device of the invention are also obviously valid in connection with the fuel cell system of the invention and vice versa.

The basic concept of the present invention consists in the fact that, in front of the fuel cell(s), a specially constructed distributing chamber is now provided, so that the entry of the medium into the fuel cell(s) can occur over a defined region of the fuel cell(s).

Provided according to the first aspect of the invention is a device for the circulation of at least one fuel cell with a medium, this device having at least one medium feed inlet for supplying the medium to the at least one fuel cell and having at least one delivery device, arranged in the medium feed inlet, for producing a defined volume flow of medium with a defined flow direction, wherein the medium feed inlet opens into a distributing chamber, in which the medium distributes itself/can distribute itself prior to entering the fuel cell(s), and wherein the distributing chamber can be brought into contact directly with the at least one fuel cell, so that the entry of the medium into the fuel cell(s) can occur over a defined region of the fuel cell(s). The device is characterized in accordance with the invention in that the device is constructed in such a way that the medium enters or can enter over the entire length of the distributing chamber with a defined flow characteristic in a directed manner in the predetermined region into the fuel cell(s) and that, in an entrance region of the distributing chamber, there is provided means for the defined distribution of the volume flow of medium into the distributing chamber.

The device of the invention makes it possible in an especially easy way to achieve an efficient circulation of the at least one fuel cell.

To this end, the device has, first of all, one medium feed inlet for supplying a medium to the at least one fuel cell. However, the invention is not thereby limited to specific media. In general, the device of the invention can be employed for any kind of medium With which circulation of the fuel cell is to be conducted. For example, this can involve media for ventilating or venting the fuel cell. It is equally possible that these media involve media for cooling or heating and/or for humidifying or dehumidifying the fuel cell. The medium can be gaseous or else liquid.

Naturally conceivable are also cases of application in which the medium involves the cathode gas flow for the fuel cell. This can involve, for example, an oxidant, such as oxygen or the like, which can be taken from the ambient air. It is equally conceivable that the medium involves the anode gas flow. In this case, the medium involves, for example, the fuel for the fuel cell, such as a hydrogen-rich gas or the like.

In accordance with the present invention, it can also be provided that the circulation of the fuel cell(s) occurs via several devices of the invention with several medium flows.

Possible by means of the invention is, in particular, an especially homogenous moisture control within the at least one fuel cell.

In order to produce a defined volume flow of medium with a defined flow direction, at least one delivery device, which is arranged in the medium feed inlet, is provided first of all in accordance with the present invention. The invention is not thereby limited to special types of delivery devices. Thus, for example, it is conceivable that the at least one delivery device is designed as a blower, as a compressor, as a pump, as a turbine, or the like. When only a single delivery device is provided and the volume flow of medium involves a gas flow, the delivery device can be designed, for example, as a blower, particularly one that can be reversed. When two or more delivery devices are employed and the medium flow is formed as a gas flow, the delivery devices can be designed, for example, in the form of blowers that are operated to apply either suction or pressure and that run in alternation. Naturally, these examples are given purely by way of example, so that other embodiment variants are also conceivable and are included in the scope of protection of the present invention. In particular, it is also possible to combine several different types of delivery devices with one another.

Advantageously, however, the delivery device is designed as a fan. Here, naturally, the most diverse fan designs are conceivable. For example, the delivery device can be constructed as a linear, axial fan. Axial fans suck in large quantities of air axially from the front and expel them toward the rear parallel to the axis of rotation. For fields of application in which a high pressure buildup with a simultaneously reduced volume flow is required, radial fans can be employed advantageously. These have, among other things, the advantage that they are cost-effective. Naturally, it is also possible to employ combinations of the two kinds of fan mentioned above, in which case so-called diagonal fans are involved. In a further embodiment, it is conceivable that the fan is constructed as a so-called cross flow fan or cross flow blower. Several advantageous embodiments of the delivery device(s) will be discussed below in great detail in the further course of the description.

A first fundamental feature of the present invention consists in the fact that the medium feed inlet opens into a distributing chamber, in which the medium can distribute itself prior to entering the fuel cell. This distributing chamber can be brought into contact directly with the at least one fuel cell. This means that the medium flowing into the distributing chamber from the medium feed inlet enters the fuel cell directly from the distributing chamber. Because the medium can distribute itself prior to entering the fuel cell, the entry of the medium into the fuel cell occurs over a defined region of the fuel cell. This region is limited only by the contour of the distributing chamber. Accordingly, through a corresponding contouring of the distributing chamber, it is possible to achieve circulation of defined regions of the fuel cell with a medium.

It is further provided in accordance with the invention that the medium can enter over the entire length of the distributing chamber with a defined flow characteristic in a directed manner in the predetermined region into the fuel cell(s). In this way, it is possible to introduce the volume flow or the partial volume flows of the medium in a desired way into the fuel cell(s). Non-exclusive examples as to how this can happen will be discussed in greater detail in the further course of the description.

As already discussed above, the medium flow must be as homogeneous as possible over the predetermined region when it enters into the fuel cell(s). With the device of the invention, it is possible that the medium flow is already directed when it enters the distributing chamber, namely, over the entire length of the distributing chamber. This already directed medium flow is then additionally distributed, in a still directed manner, within the distributing chamber, so that a homogeneous flow of the medium is produced over the entire length of the distributing chamber and the medium can subsequently enter the fuel cell(s) in a homogeneous way.

The present invention—that is, both the device and the fuel cell system—is not limited to a specific number of fuel cells. Instead, it can be provided that two or more fuel cells are present in one fuel cell system, these fuel cells being preferably arranged in series and thus forming a fuel cell pile or a fuel cell stack. It is equally possible that, in accordance with the invention, two or more fuel cell stacks are provided.

Nor is the invention limited to use in connection with specific types of fuel cells. For example, the at least one fuel cell can be constructed as a so-called PEM fuel cell. In such a fuel cell, the electrolyte consists of a proton-conducting membrane. Naturally, it is also conceivable to use other types of fuel cells.

A basic concept of the present invention consists in the fact that the medium is intended to enter the fuel cell(s) with a defined flow characteristic. To this end, the device is to be constructed in a certain way. In this connection, it is provided for in accordance with the invention that, in an entrance region of the distributing chamber, in which, for example, the medium feed inlet opens into the distributing chamber, means are provided for the defined distribution of the volume flow of medium into the distributing chamber. These means have the purpose of distributing the total volume flow of medium that enters the distributing chamber from the medium feed inlet into partial volume flows, these partial volume flows being able, in particular, to be introduced into the distributing chamber in a directed manner. Through an appropriate choice of the means, it is possible to introduce the volume flow or the partial volume flows of the medium into the distributing chamber in a desired way. Thus, for example, it is conceivable that, through the means, there occurs a uniform distribution of the volume flow of medium into the distributing chamber. Naturally, it is also conceivable that different regions of the distributing chamber are exposed to differently sized partial volume flows. This, too, can be realized by an appropriate choice of the means.

With the device of the invention, it is thus possible, in particular, to provide two regions for distribution of the medium. In the first region, which can involve an entrance region into the distributing chamber, the medium is distributed in a uniform and directed manner over the length of the distributing chamber. In a second region, which can involve the distributing chamber, the medium is distributed in a uniform and directed manner over the height of the distributing chamber and is thus distributed throughout the fuel cell. This can be achieved, for example, through an advantageous geometric design of the distributing chamber. Non-exclusive examples of this will be discussed in greater detail in the further course of the description.

It can be provided advantageously that the means for the defined distribution of the volume flow of medium are designed as a component part of the at least one delivery device. Through such an embodiment, it is possible to design the distributing chamber or its entrance region in a very simple way in terms of construction, because the distribution of the entire volume flow of medium occurs already in the delivery device. In such an embodiment variant, the delivery device opens preferably into the distributing chamber or else is arranged directly in the entrance region of the distributing chamber.

In another embodiment, it can be provided that the means for the defined distribution of the volume flow of medium are designed as component parts of the distributing chamber. In this case, the delivery device can be constructed in an especially simple manner. It only has to be capable of producing a defined volume flow of medium. The actual division or distribution of the volume flow of medium into the distributing chamber then occurs through the means for defined distribution arranged downstream of the delivery device.

Advantageously, the at least one delivery device can be constructed as a cross flow delivery device, which extends along the entrance region of the distributing chamber. Cross flow delivery devices—for example, cross flow fans or cross flow blowers—are in themselves already known. Cross flow delivery devices are employed preferably in those cases in which a large-area medium feed inlet is required. Cross flow delivery devices make possible high volume flows with low pressure buildup and are characterized in general by cylindrical impellers, which are equipped with many small blades. Flow occurs over this blade impeller twice in a radial direction during its operation. One time, a flow occurs in the suction region from the outside to the inside. Finally, in the outflow region, a flow occurs from the inside to the outside. Cross flow delivery devices can, in addition, provide diverse guide elements, by means of which vortices are formed in the blade impeller, ensuring a stable flow over the impeller.

Alternatively or in addition, at least one delivery device can be constructed as a radial fan. By means of such a fan, the medium can be introduced via an feed inlet opening into the entrance region of the distributing chamber. There, it is then possible to provide means in accordance with the invention, as described above, to direct the medium flow and to introduce it in a suitable way to the fuel cell(s).

For example, it can be provided that, in the entrance region of the distributing chamber, one or more distributing elements is/are provided for the defined distribution of the volume flow of medium. Through the use of such distributing elements, it is possible in a particularly easy way to divide up the volume flow of medium in a very targeted manner or to distribute it within the distributing chamber. The division of the volume flow of medium into a specific number of partial flows can be accomplished through the number of distributing elements used. Basically, it is sufficient when a single distributing element is provided. In such a case, the volume flow of medium would be split up into two partial flows. However, when a fine distribution of the volume flow of medium into the distributing chamber is desired, preferably two or more distributing elements are used. The size of the partial volume flows or the speed of the partial volume flows entering the distributing chamber is regulated by, among other things, the distance between two neighboring distributing elements.

It is equally possible to adjust the size and speed of the partial volume flow entering the distributing chamber by way of the design of the distributing elements. In this respect, for example, it can be provided for that at least one distributing element has at least one at least partially curved guide surface for governing the direction of a partial flow of the volume flow of medium. “Curved” can mean here that the guide surface exhibits a course that is curved at least in some regions. However, it is also conceivable that two straight or curved subregions of the guide surface abut each other or are mutually placed at an angle.

The individual distributing elements can, for example, at first be produced separately and subsequently arranged in the distributing chamber or in its entrance region. Depending on the material of the distributing elements, it is possible, for example, that the distributing elements are bonded adhesively, welded, soldered, or the like. Naturally, it is also possible to provide suitable fixing elements in the distributing chamber, by means of which the distributing elements are fixed at the desired position. These can involve, for example, clamp connectors or the like. The distributing elements can, in addition to their rheological function, also assume, for example, the purpose of bracing the distributing chamber and thus of making the entire device more stable.

Advantageously, several distributing elements can be provided in the entrance region, whereby the ends of the distributing elements projecting into the entrance region of the distributing chamber have an increasing height on going from the entrance opening into the entrance region toward the opposite-lying boundary wall of the entrance region.

Here, it can be provided, in particular, that the angle (W5) between an imaginary line along the ends of the distributing elements projecting into the entrance region and the horizontal is 0 to 30°. Advantageously, the angle (W5) can be 3 to 15 degrees, most preferably 8 degrees or about 8 degrees.

The generation of a defined flow characteristic, with which the medium can enter the fuel cell(s), can also occur, for example, by designing the distributing chamber in a specific way. In this case, the desired flow characteristic can be influenced by the geometric design of the distributing chamber.

Described below will be several non-exclusive examples of how the distributing chamber can be designed in such a case.

Preferably, it can be provided for that the distributing chamber, viewed from its entrance region toward its opposite-lying end, has a tapering, particularly an at least partially curve-shaped contour. In this way, support is provided so that the medium is distributed as uniformly as possible in the distributing chamber and enters as homogeneously as possible over the predetermined region into the fuel cell.

For example, it can be provided for that the distributing chamber is bounded by an entrance opening, a transition opening for the passage of the medium into the fuel cell(s), a first wall element, and a second wall element, the wall elements extending from the entrance opening to the transition opening. Fundamentally, the invention is not limited to specific contours or lengths of the wall elements. In regard to the second wall element, a flat second wall element that is as long as possible is of advantage for an optimal and vortex-free air supply. However, this results, of course, in an increase in the space required for the entire device, which, in turn, is a drawback. It is therefore necessary to find a good compromise between flow engineering and spatial requirement. Described in the following are several examples as to how this can be implemented successfully.

In a preferred embodiment, the length of the second wall element, that is, its extension from the entrance opening to the transition opening, can be 80-200%, preferably 130-150% of the height of the entrance opening. Naturally, other measures of length are also possible.

Here, the invention is not limited to specific sizes or contours for the entrance opening. For example, the entrance opening can have an at least essentially rectangular cross section. The height of the entrance opening can preferably lie in a range between 10 and 40 mm. In an advantageous embodiment, the entrance opening can, for example, have a height of 20 to 25 mm, particularly 22 mm. It is equally conceivable that the entrance opening has a height that is 5 to 30% of the length of the transition opening, preferably 7 to 25% of the transition opening. Naturally, the invention is not limited to the numerical examples mentioned.

For example, it can be provided that the distributing chamber is bounded by an entrance opening, an entrance region that adjoins it, a transition opening for the passage of the medium into the fuel cell(s), a first wall element, and a second wall element, the wall elements extending from the entrance region to the transition opening.

Advantageously, the first wall element and/or the second wall element can have a curved course at least in some regions. Here, it can be provided that the curved course of the first and/or second wall element is formed by at least one radius of curvature (K1, K2, K3).

In the simplest case, there is thus a constant uniform curvature over the entire length of the wall element. However, it is also conceivable that the curved course is formed by two or more different radii of curvature. In this case, the wall element consists of various segments of different curvature. It is also conceivable that the first and/or second wall element does not have a curved course over the entire length, but rather that, besides at least one wall segment with a curvature, at least also one wall segment with a straight (linear) course is provided. When the wall element has two or more segments with a curvature, wall segments with a straight (linear) course can each be present between each two curved wall segments and/or in front of and/or behind the curved wall segments. In such a case, the radii of curvature of the wall segments can be either identical or different.

Described in the following will be several non-exclusive examples for the geometric design of the wall elements.

When a wall element has a straight region, the length of this straight wall region can be, for example, 80 to 120% of the length of the transition opening. Naturally, other lengths are also conceivable, so that the invention is not limited to the examples mentioned.

When the curved course of the first wall element is formed by one radius of curvature in each case, this can be, for example, 100-200% of the length of the transition opening, preferably 140-160%, for the first wall element. When the curved course of the first wall element is formed by two radii of curvature, a first radius of curvature can be, for example, 200-500% of the length of the transition opening, preferably about 300%, and a second radius of curvature can be, for example, 15-40% of the length of the transition opening, preferably 25-35%. The length of the second wall element can be, for example, 40-120% of the length of the transition opening, preferably about 70%. Naturally, other lengths are also conceivable, so that the invention is not limited to the examples mentioned.

Advantageously, the angle (W1) between the transition opening and the tangent (T1) of the first wall element can be 20 to 90 degrees in the transition region from the first wall element to the transition opening. In one embodiment example, the angle can be, for example, 60 to 90 degrees, preferably about 70 to 80 degrees. In another example, the angle can be, for example, 30 to 60 degrees, preferably about 60 degrees. Naturally, the invention is not limited to the examples mentioned.

In a further embodiment, the angle (W2) between the tangent (T2) of the first wall element and the horizontal (H1) can be 0 to 40 degrees in the transition region from the entrance opening to the first wall element and/or from the entrance region to the first wall element. Here, various embodiments are conceivable. For example, the first wall element, viewed from the transition opening for the passage of the medium into the fuel cell(s), can have an outwardly arched course. In this case, the angle (W2) can be, for example, 0 to 10 degrees. In one embodiment example, the angle can be preferably 1 to 4 degrees. However, for example, it can also be provided for that the first wall element, viewed from the transition opening, has a contour that arches inward into the distributing chamber. In this case, the angle (W2) can be, for example, between 10 and 30 degrees. Naturally, the invention is not limited to the examples mentioned.

When the course of the first wall element is formed by a radius of curvature and an adjoining straight piece, the radius of curvature for the first wall element can be, for example, 5 to 30% of the length of the transition opening, preferably 11 to 14%. The straight course of the wall element can encompass an angle to the transition opening of 0 to 10 degrees, preferably 2 to 5 degrees. Naturally, the invention is not limited to the examples mentioned.

Furthermore, it can be provided for that, in the transition region from the second wall element to the transition opening, the angle (W3) between the tangent (T3) of the second wall element and the perpendicular (H2) is 0 to 90 degrees. In one advantageous embodiment example, the angle can be, for example, 5 to 25 degrees, preferably 10 to 20 degrees. In another example, the angle can be, for example, 10 to 40 degrees, preferably 20 to 30 degrees. In yet another embodiment example, the angle can be, for example, 0 to 15 degrees, preferably 0 to 5 degrees. Naturally, the invention is not limited to the examples mentioned.

Advantageously, in the transition region from the entrance opening to the second wall element and/or from the entrance region to the second wall element, the angle (W4) between the tangent (T4) of the second wall element and the perpendicular (H2) is 5 to 90 degrees. In one embodiment example, the angle can be, for example, 10 to 30 degrees, preferably about 20 degrees. In another example, the angle can be, for example, 30 to 60 degrees, preferably 40 to 50 degrees. In still another embodiment example, the angle can be, for example, 70 to 90 degrees, preferably 80 to 90 degrees. Naturally, the invention is not limited to the examples mentioned.

When the second wall element has an at least partially curved course, this can consist, for example, of a curved segment and a straight segment. In an advantageous embodiment, the length of the second wall element can be 120 to 150% of the height of the entrance opening. The radius of curvature of the curved segment can be, for example, 0 to 30% of the length of the transition opening, preferably about 3 to 10%.

In a further embodiment, it can be provided for that at least one dividing plate is provided, which forms two or more flow channels within the distributing chamber, at least in some regions. The dividing plate can involve, for example, specially designed fins, which make possible better flow characteristics of the volume flow of medium within the distributing chamber. For example, the dividing plates make it possible to prevent or reduce vortices within the distributing chamber. The number or arranged positions of the dividing plates can differ in each case depending on the applied case and they can be adjusted in an individual manner. The position of the dividing plates is thereby dependent on the degree of settling of the fuel cell stack.

The dividing plates can be designed in straight, curved, or partially curved form. When a curvature is present, the radius can be, but need not be exclusively, for example, 5 to 25% of the length of the transition opening.

Advantageously, it can be provided for that the at least one delivery device is designed to be variable in its delivery direction and/or in its delivered quantity. In particular, it can be provided for that the delivery device can be operated with a changing load. This means that the power of the delivery device and thus the delivered quantity to be managed by the delivery device can be varied. For example, it can be provided for that the load of the delivery device can be adjusted in steps. Equally advantageous, however, is also a continuously variable load by which the feeding device is operated.

In a further embodiment, it is possible to provide at least one control device, whereby the at least one delivery device is controlled through the control device. To this end, the control device can dispose, for example, over suitable program means.

Provided in accordance with the second aspect of the invention is a fuel cell system that has at least one fuel cell with an feed inlet for a medium inflow and with at least one outlet for a medium outflow. The fuel cell system is characterized in accordance with the invention in that the feed inlet and/or the outlet is provided with at least one device in accordance with the invention as described above. The medium inflow of the fuel cell is fed through the feed inlet. This medium flow is carried away via the outlet as a medium outflow from the fuel cell after its residence in the fuel cell.

Here, however the invention is not limited to a specific number of devices. Fundamentally, it is sufficient that only a single device be provided, which is then arranged in the feed inlet or the outlet. This device then has advantageously a delivery device, which can be reversibly switched with respect to its delivery direction.

Preferably, it can be provided for that, both in the feed inlet and in the outlet, a device in accordance with the invention, as described above, is provided in each case and that, depending on the activation and delivery direction of the delivery devices, one of the devices is designed for the circulation of the fuel cell(s) to supply the volume flow of medium into the fuel cell(s), the other device in each case being designed for carrying away the volume flow of medium out of the fuel cell(s).

In this case, the two devices are arranged at least approximately point-symmetrically with respect to the center of the fuel cell(s) or of the fuel cell stack.

When two devices are used, the distributing chamber serves the device that is designed for carrying away the volume flow of medium as a collecting chamber, in which the medium emerging from the fuel cell is initially collected. This collecting chamber is then connected to a medium outlet, through which the medium present in the collecting chamber can be transported away.

Through the design of the fuel cell system described above, it is now possible in an especially simple way to achieve a homogeneous distribution of moisture within the fuel cell(s). This can occur through the fact that the flow direction of the medium flow all the way through the fuel cell(s) is at least temporarily reversed. In order to achieve this, one of the devices can be in operation in each case, this meaning that the corresponding delivery device is activated. The other device in each case is advantageously out of operation. Naturally, it is also conceivable that both devices or the delivery devices situated therein are permanently in operation. In this case, the delivery directions of the delivery devices are advantageously adjusted in such a way that one delivery device works in pressure operation and the other delivery device works simultaneously in suction operation. When the flow direction is reversed, then, the delivery directions of the two delivery devices are reversed. To this end, it can be provided for, in particular, that the two delivery devices are each connected to a control device. Provided for especially preferably in this case is that the two delivery devices or all of the delivery devices dispose over a single, common control device. Naturally, it is also conceivable that each of the delivery devices disposes over its own control device and that the individual control devices communicate with each other, preferably through a common computer unit.

In a further embodiment, it can be provided for that the fuel cell system has at least one fuel cell stack made up of two or more fuel cells arranged in series. In such a case, the distributing chamber of the at least one device for the circulation of the fuel cells is preferably in contact directly with a defined region of the fuel cell stack, in particular in its longitudinal extension.

The device of the invention for circulation can advantageously have a dimension that extends beyond the actual fuel cell stack to its end plates. The device accordingly rests on the end plates and can thus bring about a stabilizing effect with respect to the entire fuel cell stacks.

The circulation device of the invention is suitable, in particular, for a small pressure drop and a homogeneity in the air distribution over the entire fuel cell stack. This is achieved, for example, through the special inflow and outflow cross section, through the arrangement and the positioning angles of the individual distributing elements (deflecting elements). The sum of all design measures leads, for example, to the fact that, for air supply of the fuel cell(s), normal, low-cost radial fans can be used. As needed, it is also naturally possible to utilize other sources, such as gas ring compressors, Roots compressors, and the like. A further advantage is that the air supply for a system with open cathodes (not pressure-loaded) can be built very compactly.

The invention will be described in greater detail on the basis of embodiment examples with reference to the attached drawings. Shown therein are the following:

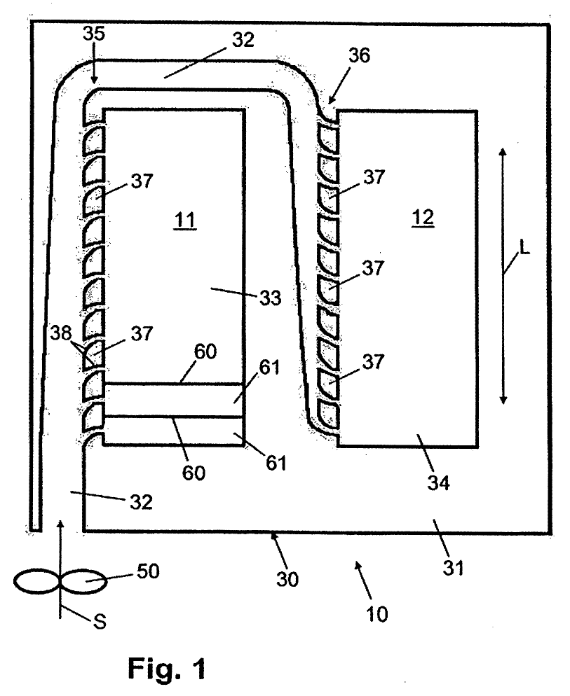

FIG. 1 a plan view, in schematic representation, onto a fuel cell system with a device of the invention for the circulation of at least one fuel cell in accordance with a first embodiment example of the invention;

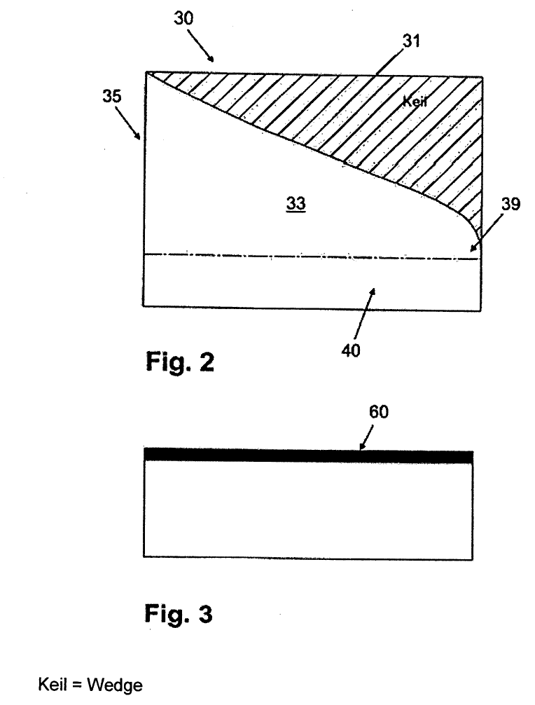

FIG. 2 a cross section, in schematic representation, through a distributing chamber of a device of the invention for the circulation of at least one fuel cell;

FIG. 3 a dividing plate, in schematic view, for use in a distributing chamber of a device of the invention for the circulation of at least one fuel cell;

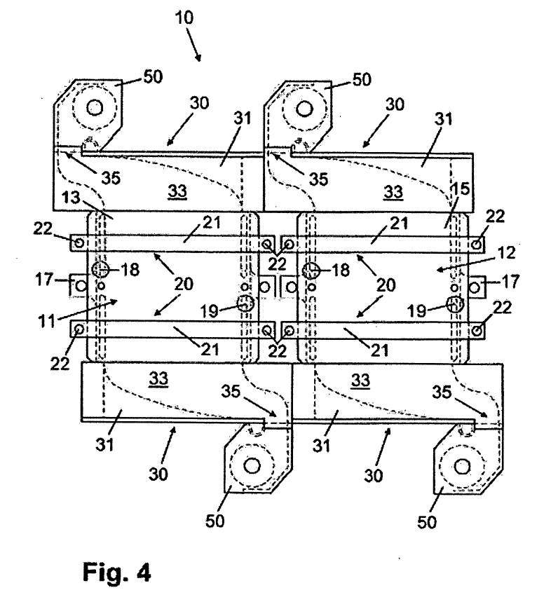

FIG. 4 a further embodiment, in schematic cross-sectional view, of a fuel cell system of the invention with devices of the invention for the circulation of at least one fuel cell;

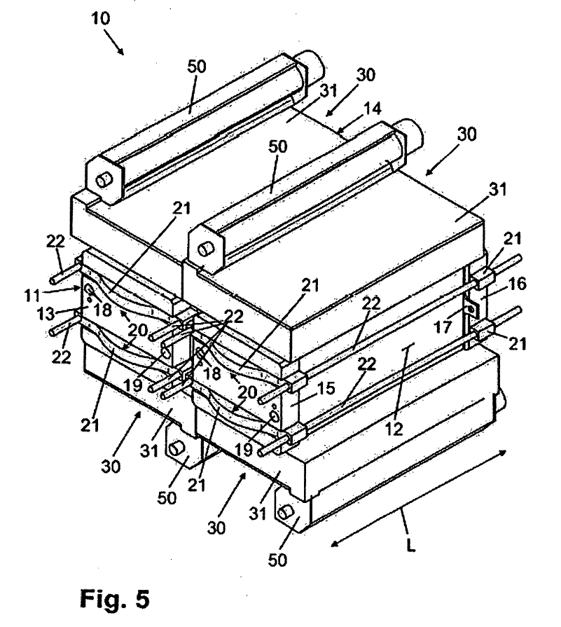

FIG. 5 a perspective drawing of the fuel cell system represented in FIG. 4;

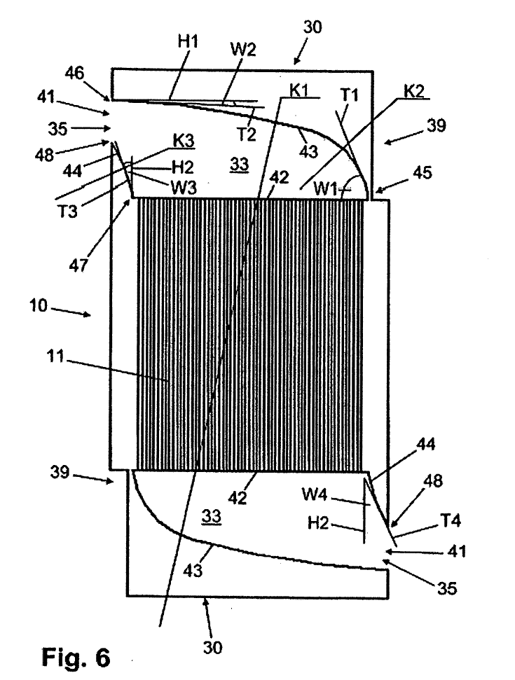

FIG. 6 a schematic drawing of another embodiment of the fuel cell system of the invention;

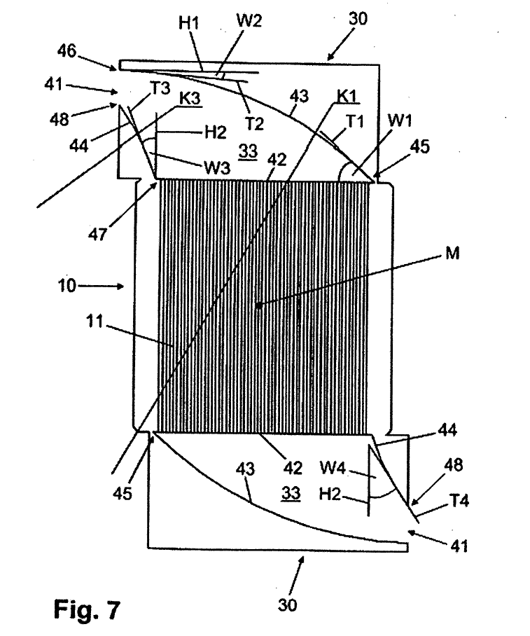

FIG. 7 a schematic representation of a further embodiment of the fuel cell system of the invention;

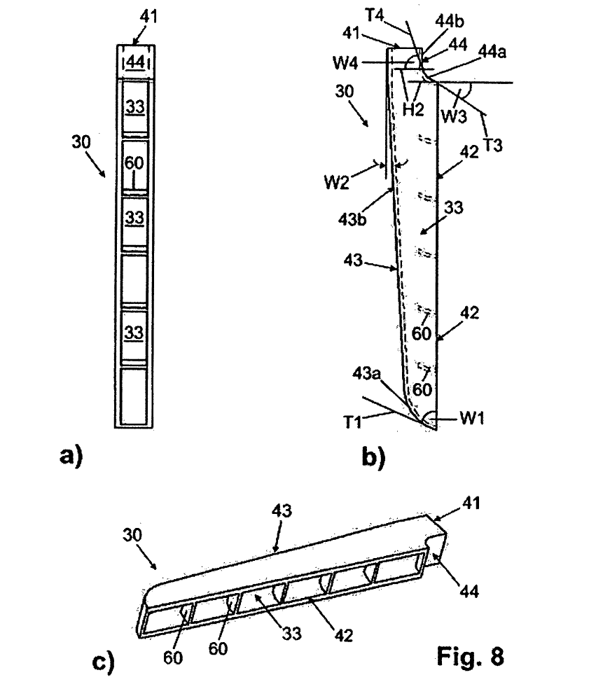

FIG. 8a) representations of yet another embodiment of the device of the c) invention for the circulation of a fuel cell;

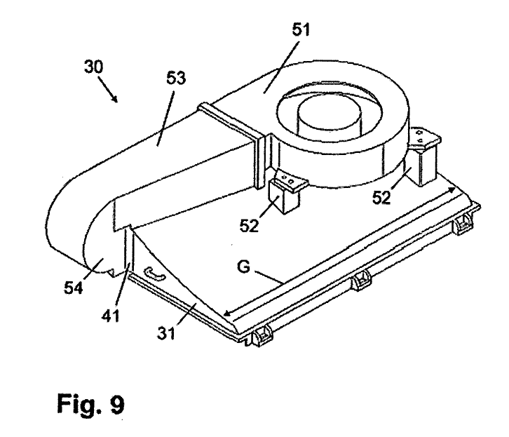

FIG. 9 a perspective drawing of another embodiment of a device of the invention for the circulation of at least one fuel cell;

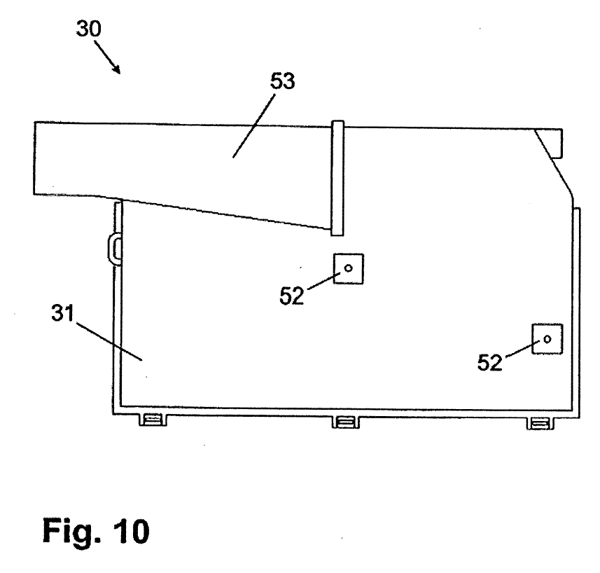

FIG. 10 a plan view onto the device represented in FIG. 9 for the circulation of at least one fuel cell;

FIG. 11 a side view of the device represented in FIGS. 9 and 10 for the circulation of at least one fuel cell;

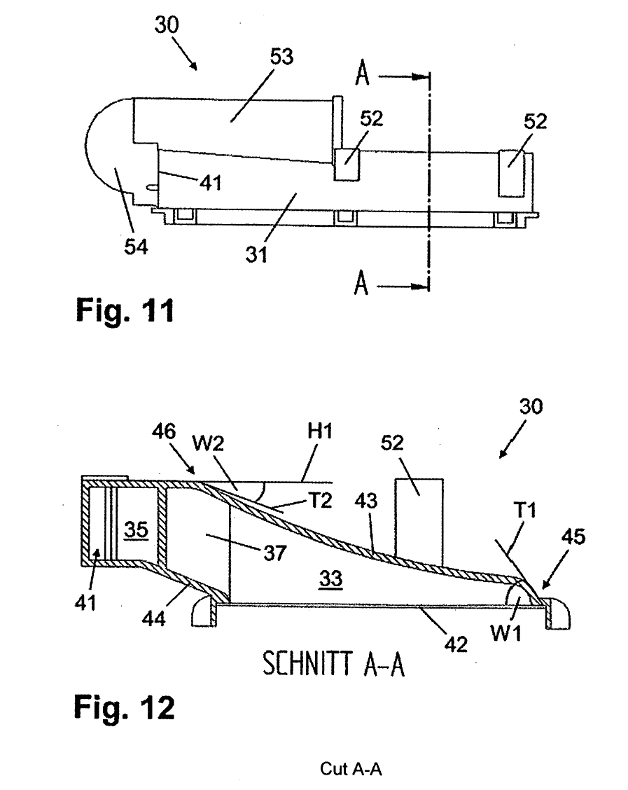

FIG. 12 a sectional representation, along the line of cut A-A in FIG. 11, of the distributing chamber of the device for the circulation of at least one fuel cell;

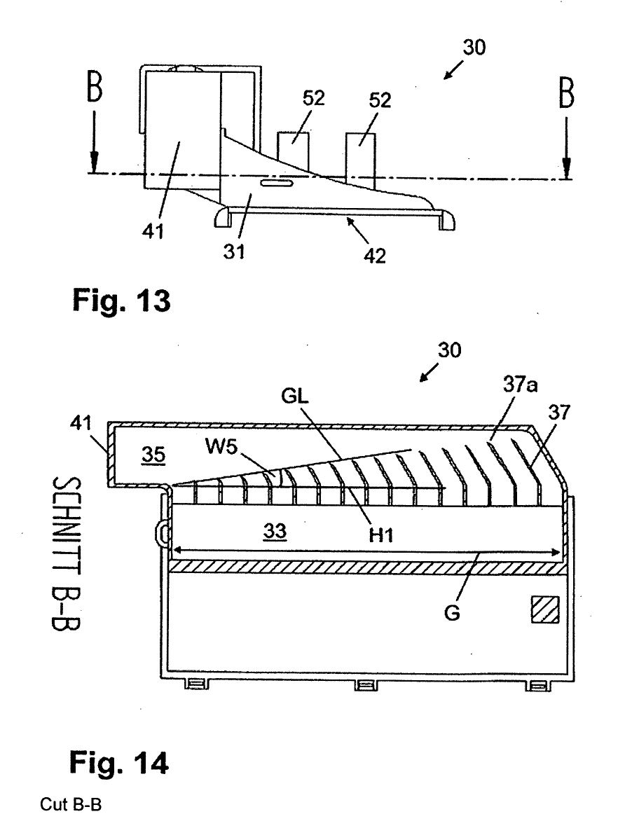

FIG. 13 a frontal view of the device represented in FIGS. 9 and 10 for the circulation of at least one fuel cell; and

FIG. 14 a sectional representation, along the line of cut B-B in FIG. 13, through the device for the circulation of at least one fuel cell.

Represented in FIG. 1 is a fuel cell system 10, which, first of all, has two fuel cell stacks 11 and 12. The individual fuel cell stacks 11 and 12 consist of a series of fuel cells, each of which consists of a number of plates. The individual plates or the individual fuel cells are arranged or stacked in series in the longitudinal direction L of the fuel cell stacks 11 and 12. Chosen in FIG. 1 is a form of representation that makes possible a plan view onto the fuel cell stacks 11 and 12.

The fuel cell stacks 11 and 12 are to undergo circulation with a medium. In the present case, what is involved is air, which is used within the fuel cells for moisture control. In particular, the circulation of the fuel cells is to make possible a homogeneous control of moisture within the fuel cells.

Provided for this purpose is a device 30 for the circulation of the fuel cell stacks 11 and 12, which, first of all, has a housing 31. Situated inside of the housing 31 is a medium feed inlet 32, via which the air medium is transported to the fuel cell stacks 11 and 12. In order to produced a defined volume flow of medium with a defined flow direction S, a delivery device 50 is provided in the medium feed inlet 32 and, in the present example, is constructed as a fan or blower. By means of the blower 50, there is produced a directed volume flow, which is fed into the medium feed inlet 32.

The medium feed inlet 32 opens into a distributing chamber 33, 34 in each case, via which the medium can flow over a defined region into the fuel cell stacks 11, 12. The distributing chambers 33, 34 are designed in such a way that the medium can distribute itself freely prior to entering the fuel cell stacks 11, 12.

Provided for this purpose, in an entrance region 35, 36 of the distributing chambers 33, 34 in which the medium feed inlet 32 opens into the distributing chambers 33, 34, are means for the defined distribution of the volume flow of medium into the distributing chambers 33, 34.

Here, these means are designed as a component part of the distributing chambers 33, 34 and have a number of distributing elements 37. The distributing elements 37 are each arranged at a specific spacing with respect one another, so that, between them, an entrance opening for the medium into the distributing chambers 33, 34 is formed. Through the spacing of the individual distributing elements 37 with respect to one another, the volume flow of medium flowing through the medium feed inlet 32 can be divided up into a number of partial volume flows. In this way, it is ensured that the volume flow of medium is distributes itself as uniformly as possible within the distributing chamber 33, 34 before it enters into the fuel cell stacks 11, 12. In order to adjust more precisely the given direction of the partial volume flows, it is provided for, in the example in accordance with FIG. 1, that the distributing elements 37 each have curved guide surfaces 38.

In order to obtain improved flow relationships within the distributing chambers 33, 34 and, in particular, in order to prevent vortex formation of the medium, a number of dividing plates 60 are provided in the distributing chambers 33, 34. These dividing plates 60 result in the creation of a number of flow channels 61, which facilitate a directed feeding of the medium into the fuel cells 11, 12. For purposes of a better overview, only two dividing plates 60 are represented in FIG. 1. The positions of the individual dividina plates 60 ensue, in particular, according to the degree of settling of the fuel cell stacks 11, 12.

Represented in FIG. 2 is a schematic partial cross-sectional view of a device 30 for the circulation of at least one fuel cell. Once again, a distributing chamber 33 is represented within the housing 31. In order to ensure the uniform distribution of the medium within the distributing chamber 33 as well as the uniform circulation of the fuel cell stacks, the distributing chamber 33 in accordance with FIG. 2 has, when viewed from its entrance region 35 toward its opposite-lying end 39, a tapering contour. In the present example, the contour is chosen in such a way that the distributing chamber 33 has essentially a wedge-shaped structure from its entrance region 35 toward its opposite-lying end 39.

In the bottom region of the distributing chamber 33, which corresponds to the region that is contact with the fuel cell stacks and over which the medium enters the fuel cell stacks, there is a receiving region 40 that is provided for a matting element, which is not represented in greater detail. The matting element can have the function, for example, of cleaning in advance the medium flow entering the fuel cell stacks. In this case, the matting element involves a filter element. Naturally, such a matting element can also serve to divide further the partial volume flows of the medium that enter the distributing chamber 33, so that the medium can be fed into the fuel cell stacks in a very fine manner. The matting element can be formed, for example, out of fibers. Advantageously, the matting element can be formed out of a material that removes moisture from the medium flow that is flowing through.

FIG. 3 shows, in schematic view, a dividing plate 60, which, in terms of its dimensioning, could fit, for example, into the receiving region 40 of the distributing chamber 33 represented in FIG. 2. In particular, the dividing plates 60 have to fit into the distributing chamber 33 in such a way that they do not cover any openings in the individual fuel cells or fuel cell plates of the fuel cell stacks.

Represented in FIGS. 4 and 5 is a further embodiment example of a fuel cell system 10 of the invention. Once again, the fuel cell system 10 consists of two fuel cell stacks 11, 12, for which, between each of the end plates 13, 14 or 15, 16, stacks of fuel cells or fuel cell plates are situated. The fuel cell stacks 11, 12 have a lengthwise extension L.

Represented in each of the end plates 13, 15 are openings 18 for supplying oxidant or openings 19 for carrying away fuel. Corresponding openings for supplying oxidant or carrying away fuel are also provided in the end plates 14, 16, but they are not explicitly represented in the figures.

For removal of the electrical current generated by the fuel cells, the fuel cell stacks 11, 12 have corresponding electrical current collector plates 17.

In order for the fuel cell stacks 11, 12, which consist of plate stacks, to remain fixed in their contour, corresponding bracing devices 20 are provided. These bracing devices 20 each consist of spring elements 21, which are joined to one another through corresponding bracing rods 22. In this way, the fuel cell stacks 11, 12 can be firmly joined together. Moreover, the individual plates of the fuel cell stacks 11, 12 are usually bonded adhesively to one another in addition.

In order to ventilate the fuel cell stacks 11, 12 in an adequate and appropriate manner, so that, in the fuel cell stacks 11, 12, a homogeneous distribution of moisture can be realized and in order that the fuel cells stacks 11, 12 can be cooled in a suitable manner, two devices 30 for the circulation of the fuel cell stacks 11, 12 are provided for each fuel cell stack 11, 12. The devices 30 are each arranged in lengthwise extension L of the fuel cell stacks 11, 12 on opposite-lying sides of the fuel cell stacks 11, 12. Each of the devices 30 disposes, in turn, over a housing 31, in which a distributing chamber 33 is provided. Similar to the example represented in FIG. 1, a volume flow of medium is distributed, in turn, uniformly in the distributing chamber 33, so that it can enter the fuel cell stacks 11, 12 over a defined region of the latter. To this end, in turn, means for the defined distribution of the volume flow of medium into the distributing chamber 33 are provided. For the example represented in FIGS. 4 and 5, these means are constructed, however, as component parts of the delivery devices 50. The medium flow is introduced through the delivery devices 50 into the distributing chamber 33 and thus into the fuel cell stacks 11, 12 with a defined flow direction.

In the example represented in FIGS. 4 and 5, the delivery devices 50 are constructed in the form of cross flow delivery devices—for example, in the form of cross flow fans or cross flow blowers. This cross flow delivery devices 50 extend along the entrance region 35 of the distributing chambers 33. Cross flow delivery devices are particularly suitable for making available a large-area supply of medium.

The delivery devices 50 of the devices 30 or the use of two devices in each case at respectively opposite-lying sides of the fuel cell stacks 11, 12 makes it possible that the flow direction of the medium through the fuel cell stacks 11, 12 can be reversed during operation. This ensures an especially homogeneous flow through the fuel cell stacks 11, 12.

Represented in FIGS. 6 and 7 are two embodiment examples of fuel cell systems 10 of the invention, for which the defined flow characteristic with which the medium can enter the predetermined region of a fuel cell stack 11 is brought about through a special geometric design of the distributing chamber 33.

Provided both in the feed inlet and in the outlet for the fuel cell stack 11 is a device 30 for the circulation. As is revealed, in particular, by FIG. 7, the two devices are arranged in roughly point symmetry with respect to the center M of the fuel cell stack 11.

The devices 30 in accordance with FIGS. 6 and 7 each have a distributing chamber 33, which is bounded by an entrance opening 41, a transition opening 42 (for the passage of the medium out of the distributing chamber 33 and into the fuel cell stack 11), a first wall element 43, and a second wall element 44. The entrance opening 41 has a height of 22 mm. The first wall element 43 and the second wall element 44 each have a curved course and each extend from the entrance opening 41 all the way to the transition opening 42.

The maximum height of the distributing chamber 33 in the region of the entrance opening 41 is 50 mm and the maximum length of the distributing chamber is 140 mm.

The second wall element 44, in both FIGS. 6 and 7, each has a curved course that is formed by a single radius of curvature K3. The first wall element 43, in FIG. 6, has a curve course that is formed by two radii of curvature K1 and K2. The first wall element 43 in accordance with FIG. 7 has a curved course that is formed by a single radius of curvature K1.

For the embodiment example in accordance with FIG. 6, the first wall element 43 is constructed in such a way that, in the transition region 45 between the first wall element 43 and the transition opening 42, the angle W1 between the tangent T1 of the first wall element 43 as well as the transition opening is 60 to 90 degrees, ideally about 80 degrees. The radius of curvature K2 in this region is preferably 15-40% of the length of the transition opening 42 (that is, of its extension between the first wall element 43 and the second wall element 44), ideally about 25-35%. The further radius of curvature K1 adjoining the radius of curvature K2 is preferably 200-500% of the length of the transition opening 42, ideally about 300%. In the transition region 46 from the entrance opening 41 to the first wall element 43, the angle W2 between the tangent T2 of the first wall element 43 as well as the horizontal H1 is preferably 0 to 10 degrees, ideally about 1 to 4 degrees.

The second wall element 44 in accordance with FIG. 6 preferably has a length that corresponds to 80 to 200% of the height of the entrance opening 41, ideally 130 to 150%. The length of the second wall element 44 corresponds here to the stretch of the transition region 48 between the entrance opening 41 and the second wall element 44 up to the transition region 47 between the second wall element 44 and the transition opening 42. In the transition region 48 from the entrance opening 41 to the second wall element 44 (this is represented in the lower part of FIG. 6), the angle W4 between the tangent T4 of the second wall element as well as the perpendicular H2 is preferably 10 to 30 degrees, ideally about 20 degrees. In the transition region 47 from the transition opening 42 to the second wall element 44, the angle W3 between the tangent T3 of the second wall element 44 as well as the perpendicular H2 is preferably 5 to 25 degrees, ideally about 10 to 20 degrees. The second wall element 44 has preferably a curved course with a radius of curvature K3 that is advantageously 40-120% of the length of the transition opening 42, ideally about 70%.

Through the device 30 or the correspondingly designed distributing chamber 33, the medium that enters into the distributing chamber 33 distribute itself especially well and be introduced in a defined manner into the fuel cell stack 11.

The fuel cell system 10 represented in FIG. 7 has, in the feed inlet and in the outlet, two devices 30, which, in their basic structure, correspond to the devices represented in FIG. 6. In contrast to the embodiment example represented in

FIG. 6, the devices 30 in accordance with FIG. 7 dispose over a first wall element 43 that has a curved course formed by only one radius of curvature K1.

The geometric design of the device 30 ensues here as follows.

The first wall element 43 is constructed in such a way that, in the transition region 45 between the first wall element 43 and the transition opening 42, the angle W1 between the tangent T1 of the first wall element 43 as well as the transition opening is 30 to 60 degrees, ideally about 40 degrees. The radius of curvature K1 of the first wall element 43 is preferably 100-300% of the length of the transition opening 42, ideally about 140-160%. In the transition region 46 from the first entrance opening 41 to the first wall element 43, the angle W2 between the tangent T2 of the first wall element 43 as well as the horizontal H1 is preferably 0 to 10 degrees, ideally about 1 to 4 degrees.

The second wall element 44 in accordance with FIG. 7 preferably has a length that corresponds to 80 to 200% of the height of the entrance opening 41, ideally 130 to 150%. In the transition region 48 from the entrance opening 41 to the second wall element 44 (this is represented in the lower part of FIG. 7), the angle W4 between the tangent T4 of the second wall element 44 as well as the perpendicular H2 is preferably 30 to 60 degrees, ideally about 40 to 50 degrees. In the transition region 47 from the transition opening 42 to the second wall element 44, the angle W3 between the tangent T3 of the second wall element 44 as well as the perpendicular H2 is preferably 10 to 40 degrees, ideally about 20 to 30 degrees. The second wall element 44 has preferably a curved course with a radius of curvature K3 that advantageously is 40-120% of the length of the transition opening 42, ideally about 70%.

The embodiment examples represented in FIGS. 6 and 7 allow the medium entering the distributing chamber 33 to distribute itself especially well and to be introduced into the fuel cell stack. At the same time, only a small spatial requirement for the circulation devices 30 is needed. The invention is not hereby limited to the numerical examples mentioned, so that other geometries of the object of the present invention are also included.

A further embodiment of a device 30 of the invention for the circulation of at least one fuel cell is represented in FIGS. 8a to 8c . The device 30 has, as in the embodiment examples described above, a distributing chamber 33, in which are situated a series of dividing plates 60, which have been described further above.

The distributing chamber 30 is bounded by an entrance opening 41, a transition opening 42, a first wall element 43, and a second wall element 44. The first wall element 43 and the second wall element 44 have a curved course at least in some regions. For the basic construction as well as the basic functional operation of the distributing chamber 33 and the device 30, reference is also made to the preceding embodiments in the framework of FIGS. 1 to 7.

The dividing plates 60 are constructed in a curved configuration in the example, but they can also be designed in straight form. The dividing plates 60 can, in their curved form, have a radius of, for example, about 5 to 25% of the length of the transition opening 42.

The second wall element 44 consists—viewed from the direction of the entrance opening 41—of a straight (linear) segment 44b and an adjoining, curved segment 44a . The total length of the second wall element 44 is preferably 80 to 200% of the height of the entrance opening 41, ideally 120 to 150%. The radius of curvature of the curved segment 44a is, for example, 0 to 30% of the length of the transition opening 42, ideally 3 to 10%. The entrance opening 41 can have a height of between 20 and 25 mm, ideally a height of between 22 and 24 mm. The transition opening 42 can, in this example, have a length of 300 mm. The first wall element 43 also has a straight (linear) segment 43b and an adjoining curved segment 43a . The radius of curvature of the curve segment 43a can be, for example, 5 to 30% of the length of the transition opening 42, preferably 11 to 14%. The straight segment 43b of the wall element 43 can have an angle W2 to the plane of the transition opening 42 of 0 to 10 degrees, preferably 2 to 5 degrees. The length of the straight wall segment 43b can be, for example, 80 to 120% of the length of the transition opening 42.

In the transition region from the first wall element 43 to the transition opening 42, the angle W1 between the transition opening 42 and the tangent T1 of the first wall element 43 is advantageously 60 to 90 degrees, preferably 70 to about 80 degrees. In the transition region from the second wall element 44 to the transition opening 42, the angle W3 between the tangent T3 of the second wall element 44 and the perpendicular H2 can advantageously be 0 to 15 degrees, preferably 0 to 5 degrees. In the transition region from the entrance opening 41 to the second wall element 44, finally, the angle W4 between the tangent T4 and the perpendicular H2 can be preferably 70 to 90 degrees, ideally 80 to 90 degrees.

Finally, represented in FIGS. 9 to 14 is yet another embodiment example for a device 30 for the circulation of at least one fuel cell. In regard to the basic functional operation of the circulation device 30, attention is drawn, first of all, to the preceding description in regard to the other embodiment examples in full and reference is made to these.

The radial fan 51 generates the air that is introduced into the distributing chamber 33 and is to be fed over this in a homogeneous and directed way to the fuel cell(s). To this end, the air generated by the radial fan 51 is fed, first of all, through an entry channel 53 and a deflecting channel 54 of the entrance opening 41 of an entrance region 35 of the distributing chamber 33.

The entrance region 35 becomes the actual distributing chamber 33. In order for the medium to be able to enter, already in the entrance region 35, over the entire length G of the distributing chamber 33 with a defined flow characteristic in a directed manner into the predetermined region of the fuel cells, distributing elements 37 are provided in the entrance region 35 (FIG. 14). The distributing elements 37 have curved guide surfaces and, in the present example, the distributing elements 38 consist of two respectively straight subelements and the subelements are positioned at an angle to each other.

In order to ensure a homogeneous inflow of the medium out of the entrance region 35 into the actual distributing chamber 33, it is provided for, as can be seen, in particular, from FIG. 14, that the ends 37a of the distributing elements 37 projecting into the entrance region 35 of the distributing chamber have an increasing height on going from the entrance opening 41 into the entrance region 35 toward an opposite-lying boundary wall 65 of the distributing chamber 33.

Here, the increase in the height of the distributing elements 37 is chosen in such a way that the angle W5 between an imaginary line GL along the ends 37a of the distributing elements 37 projecting into the entrance region 35 and the horizontal H1 is 0 to 30 degrees, preferably 3 to 15 degrees and quite particularly preferably 8 degrees. In this way, it is ensured that the medium flowing into the entrance region 35 enters into the distributing chamber 33 in a directed manner over the entire length G of the circulation device 30.

In order to maintain this directed flow and possibly to optimize it further, the distributing chamber 33 is itself designed in a special way. This is to discussed on the basis of the sectional representation in FIG. 12.

As is evident from FIG. 12, the medium entering the entrance region 35 is first divided up by the distributing elements 37 into uniform partial flows (this being ensured by the different height of the distributing elements 37) and introduced into the distributing chamber 33 in a directed manner (namely, over its entire length). In order that the medium subsequently can be introduced into the fuel cells in a directed manner, the distributing chamber 33 has specially constructed wall elements.

As is particularly evident from FIG. 12, the distributing chamber 33 is bounded by the entrance opening 41, the adjoining entrance region 35, a transition opening 42 for the passage of the medium into the fuel cells, a first wall element 43, and a second wall element 44. Here, the wall elements 43, 44 extend from the entrance region 35 to the transition opening 42.

The first wall element 43 is constructed in such a way that, in the transition region 45 between the first wall element 43 and the transition opening 42, the angle W1 between the tangent T1 of the first wall element 43 as well as the transition opening is 60 to 90 degrees, ideally about 80 degrees. In the transition region 46 from the entrance region 35 to the first wall element 43, the angle W2 between the tangent T2 of the first wall element 43 as well as the horizontal H1 is preferably 10 to 40 degrees, ideally about 15 to 30 degrees.

Whereas the circulation device 30 represented in FIGS. 6 and 7 has a first wall element 43 that, viewed from the transition opening 42 for the passage of the medium into the fuel cell(s), has an outwardly arched curve, the first wall element 43 represented in FIGS. 9 to 14, viewed from the transition opening 42, has a contour that arches inward into the distributing chamber 33.

List of Reference Numbers

10 fuel cell system
11 fuel cell stack
12 fuel cell stack
13 end plate
14 end plate
15 end plate
16 end plate
17 electrical current collector plate
18 oxidant feed inlet
19 fuel outlet
20 bracing device
21 spring element
22 bracing rods
30 device for the circulation of at least one fuel cell
31 housing
32 medium feed inlet
33 distributing chamber
34 distributing chamber
35 entrance region into the distributing chamber
36 entrance region into the distributing chamber
37 distributing element
37a end of the distributing element
38 guide surface
39 opposite-lying end of the distributing chamber with respect to the entrance region
40 receiving region
41 entrance opening
42 transition opening
43 first wall element
43a curved wall segment
43b straight wall segment
44 second wall element
44a curved wall segment
44b straight wall segment
45 transition region of the first wall element to the transition opening
46 transition region of the entrance opening to the first wall element
47 transition region of the second wall element to the transition opening
48 transition region of the entrance opening to the second wall element
50 delivery device
51 radial fan
52 attachment device
53 entry channel
54 deflecting channel
60 dividing plate
61 flow channel
65 boundary wall of the distributing chamber
G total length of the distributing chamber
GL imaginary line
H1 horizontal
H2 horizontal
K1 radius of curvature
K2 radius of curvature
K3 radius of curvature
L lengthwise extension of the fuel cell stack
M center of the fuel cell(s)
S flow direction of the volume flow of medium
T1 tangent
T2 tangent
T3 tangent
T4 tangent
W1 angle
W2 angle
W3 angle
W4 angle
W5 angle

1. A device for the circulation of at least one fuel cell with a medium, this device having at least one medium feed inlet for supplying the medium to the at least one fuel cell and having at least one delivery device, arranged in the medium feed inlet, for producing a defined volume flow of medium with a defined flow direction, wherein the medium feed inlet opens into a distributing chamber, in which the medium distributes itself/can be distributed prior to entering the fuel cell(s), and wherein the distributing chamber can be brought into contact directly with the at least one fuel cell, so that the entry of the medium into the fuel cell(s) can occur over a predetermined region of the fuel cell(s), characterized in that the device is designed so that medium enters or can enter over the entire length of the distributing chamber with a defined flow characteristic in a directed manner in the predetermined region into the fuel cell(s) and that, in the entrance region of the distributing chamber, there are provided means for the defined distribution of the volume flow of medium into the distributing chamber.

2. The device according to claim 1, further characterized in that the means for the defined distribution of the volume flow of medium are constructed as a component part of the at least one delivery device.

3. The device according to claim 1, further characterized in that the means for the defined distribution of the volume flow of medium are constructed as a component part of the distributing chamber.

4. The device according to claim 1, further characterized in that the at least one delivery device is constructed as a cross flow delivery device, which extends along the entrance region of the distributing chamber and/or the delivery device is constructed as a radial fan.

5. The device according to claim 1, further characterized in that one or more distributing element(s) is/are provided in the entrance region of the distributing chamber for the defined distribution of the volume flow of medium.

6. The device according to claim 5, further characterized in that at least one distributing element has an at least partially curved guide surface for governing the direction of a partial flow of the volume flow of medium.

7. The device according to claim 5, further characterized in that several distributing elements are provided, that the ends of the distributing elements projecting into the entrance region of the distributing chamber have an increasing height on going from the entrance opening into the entrance region toward an opposite-lying boundary wall of the entrance region.

8. The device according to claim 7, further characterized in that the angle between an imaginary line along the ends of the distributing elements projecting into the entrance region and the horizontal is 0 to 30 degrees, preferably 3 to 15 degrees, particularly 8 degrees.

9. The device according to claim 1, further characterized in that the distributing chamber itself is constructed in such a way that the medium can enter the fuel cell(s) with a defined flow characteristic in the predetermined region and that the distributing chamber, viewed from its entrance region toward its opposite-lying end has a tapering contour, particularly one proceeding at least partially in a curved shape.

10. The device according to claim 1, further characterized in that the distributing chamber is bounded by an entrance opening, a transition opening for the passage of the medium into the fuel cell(s), a first wall element, and a second wall element, the wall elements extending from the entrance opening to the transition opening.

11. The device according to claim 1, further characterized in that the distributing chamber is bounded by an entrance opening an entrance region that adjoins it, a transition opening for the passage of the medium into the fuel cell(s), a first wall element and a second wall element, the wall elements extending from the entrance region to the transition opening.

12. The device according to claim 10, further characterized in that the first wall element and/or the second wall element have a curved course at least in some regions and that the curved course of the first and/or second wall element is formed by at least one radius of curvature.

13. The device according to claim 10, further characterized in that, in the transition region from the first wall element to the transition opening, the angle between the transition opening and the tangent of the first wall element is 20 to 90 degrees.

14. The device according to claim 10, further characterized in that, in the transition region from the entrance opening to the first wall element and/or from the entrance opening to the first wall element, the angle between the tangent of the first wall element and the horizontal is 0 to 40 degrees.

15. The device according to claim 10, further characterized in that, in the transition region from the second wall element to the transition opening, the angle between the tangent of the second wall element and the perpendicular is 0 to 90 degrees.

16. The device according to claim 10, further characterized in that, in the transition region from the entrance opening to the second wall element and/or from the entrance region to the second wall element, the angle between the tangent of the second wall element and the perpendicular is 5 to 90 degrees.

17. The device according to claim 1, further characterized in that, in the distributing chamber, there is provided at least one dividing plate, which forms two or more flow channels within the distributing chamber at least in some regions.

18. The device according to claim 1, further characterized in that at least one delivery device is constructed so as to be variable in its delivery direction and/or in its delivered quantity.

19. The device according to claim 1, further characterized in that at least one delivery device is connected with a control device.

20. A fuel cell system, having at least one fuel cell with at least one feed inlet for a medium inflow and at least one outlet for a medium outflow, hereby characterized in that at least one device according to claim 1 is provided in the feed inlet and/or the outlet.

21. A fuel cell system having at least one fuel cell with at least one feed inlet for a medium inflow and at least one outlet for a medium outflow, hereby characterized in that at least one device according to claim 1 is provided in the feed inlet and/or the outlet, further characterized in that, both in the feed inlet and in the outlet, there is provided a device according to claim 1 and that, depending on the activation and feed direction of the delivery devices one of the devices for circulation of the fuel cell(s) is constructed for feeding the volume flow of medium into the fuel cell(s) and the other device is constructed for carrying away the volume flow of medium out of the fuel cell(s).

22. The fuel cell system according to claim 21, further characterized in that the two devices are arranged in a point-symmetric manner with respect to the center of the fuel cell(s).

23. The fuel cell system according to claim 20, further characterized in that it has at least one fuel cell stack consisting of two or more fuel cells arranged in series and that the distributing chamber of the at least one device for circulation of the fuel cells is in contact directly with a defined region of the fuel cell stack, in particular in its lengthwise extension.
